(19) United States
(12) Patent Application Publication
(10) Pub. No.: US 2002/0004401 A1
(43) Pub. Date: Jan. 10, 2002

(54) Method for enhancing the reliability and efficiency of aeronautical data communications networks using synchronization data transmitted by VHF data link mode 4 aircraft stations

(76) Inventors: Stephen B. Heppe, Purcellville, VA (US); K. Prasad Nair, Bethesda, MD (US); Steven Friedman, Silver Spring, MD (US)

Correspondence Address: BLANK ROME COMISKY & MCCAULEY LLP, THE FARRAGUT BUILDING SUITE 1000, 900 17TH STREET NW, WASHINGTON, DC, 20006, US

(21) Appl. No.: 09/848,541

(22) Filed: May 4, 2001

Related U.S. Application Data
(60) Provisional application No. 60/203,919, filed on May 12, 2000.

(51) Int. Cl. H04Q 7/20

(52) U.S. Cl. 455/456; 455/430

(57) ABSTRACT

The present invention uses selected network management data transmitted within VDL/4 RF subnetworks, or information derived from network management data transmitted within VDL/4 subnetworks, to efficiently manage a non-VDL/4 RF subnetwork or set of subnetworks.

### REFERENCE TO RELATED APPLICATIONS

The present application claims the benefit of U.S. Provisional Application No. 60/203,919, filed May 12, 2000, whose disclosure is hereby incorporated by reference in its entirety into the present disclosure.

### FIELD OF THE INVENTION

The present invention is directed to the economical provision of data networking services to and from aircraft.

### BACKGROUND OF THE INVENTION

At present it is difficult and costly for airline passengers in commercial aircraft to access modern data communications networks. While a data call can sometimes be configured from a personal computer through an air/ground telephone, the data rate is low, link reliability is low, and line charges are high. Several commercial companies have recently announced plans to deliver higher-quality, higher-speed services at lower cost.

Airlines themselves have poor access to modern data communications networks, with current air/ground data networking for Airline Operational Control (AOC) handled via 2.4 kbps modems within the ACARS family of protocols. The ACARS air/ground environment is described in ARINC Specification 618. The capabilities of onboard equipment are defined in ARINC Characteristics 597, 724 and 724B. Other standards may also apply. ACARS uses a p-persistent carrier-sense multiple-access scheme for packet data communications. Upgrades to ACARS are planned, which will increase the burst data rate but leave the access scheme essentially unchanged.

The International Civil Aviation Organization (ICAO) has recently recommended the adoption of standards for a new VHF Data Link Mode 4 (VDL/4). VDL/4 operates at 19.2 kbps and uses a self-organizing time-division multiple-access scheme for packet data communications. Part of the channel management scheme for VDL/4 relies on aircraft position information. Another part relies on accurate time known to all participating stations. A modification of the p-persistent algorithm used by ACARS is also included for some transmissions. VDL/4 has the potential to support several user applications including automatic dependent surveillance-broadcast (ADS-B) and air/ground networking.

The following issues among others must be considered in order to deliver high-reliability, high-data-rate and low-cost two-way data networking services to passengers, crew and equipment onboard aircraft:

1. Radio-frequency (RF) subnetworks, providing air/ground connectivity directly or via satellites and other media, must be capable of providing high-data-rate communications;

2. Many existing and planned commercial high-data-rate RF subnetworks assume stationary or slowly-moving user terminals, in contrast to aircraft which move rapidly.

3. AOC and other airline- or crew-related communications are typically supported in a separate frequency band from passenger communications;

4. Many user applications, such as passenger access to the Internet, will tend to be dominated by large quantities of“uplink” data delivered to the aircraft from the ground and relatively small quantities of “downlink” data delivered to the ground from the aircraft (although occasional large downlink file transfers may occur).

5. RF subnetwork services may involve location-dependent pricing mechanisms.

6. Certain RF subnetworks may be constrained to avoid airborne transmissions in certain geographic domains, e.g. regions surrounding radio astronomy observatories.

### SUMMARY OF THE INVENTION

The present invention uses selected network management data transmitted within VDL/4 RF subnetworks, or information derived from network management data transmitted within VDL/4 subnetworks, to efficiently manage a non-VDL/4 RF subnetwork or set of subnetworks.

### BRIEF DESCRIPTION OF DRAWINGS

FIG. 1 illustrates a terrestrial air/ground data network comprising several fixed ground stations and an aircraft station.

FIG. 2 illustrates a satellite air/ground data subnetwork comprising a satellite relay, satellite earth station and aircraft station.

FIG. 3 illustrates several aircraft stations 31 and 32, and several aeronautical (fixed ground) stations 33, 34 and 35, operating in a VDL/4 network.

FIG. 4 illustrates a hybrid air/ground data network according to the present invention, comprising a VDL/4 RF subnetwork and additional RF subnetworks, wherein selected VDL/4 network management data is made available to one or more of the facilities of the additional RF subnetworks in order to enhance the efficiency of the additional RF subnetworks.

### DETAILED DESCRIPTION OF THE INVENTION

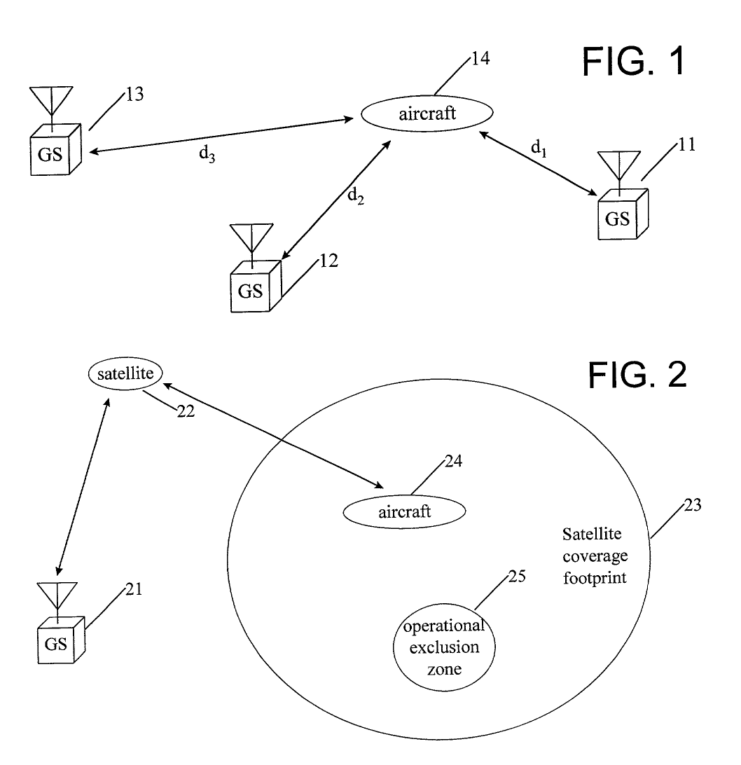

Preferred embodiments of the present invention will be set forth with reference to FIGS. 1-4.

FIG. 1 illustrates a terrestrial air/ground data network comprising several fixed ground stations 11, 12, 13 and an aircraft station 14. Examples of this type of network are the ACARS network implemented by SITA and the proposed network for VHF Data Link Mode 2. In typical operation an aircraft 14 will frequently operate with the nearest fixed ground station as determined by RF signal strength considerations (although other factors may also apply, and control algorithms may be used to minimize the frequency with which handoffs between ground stations are executed). In FIG. 1, if d₁<d₂ and d₁<d₃, the aircraft 14 would typically operate with fixed ground station 11. During the time period that the aircraft 14 is operating with fixed ground station 11, all uplink data addressed to aircraft 14 is handled through fixed ground station 11. As the aircraft moves, it will handoff from one ground station to another. In many aeronautical data communication systems, for example ACARS, an aircraft makes handoff decisions based on RF signal strength of the uplink transmissions from the various fixed ground stations which it can detect. However, due to variations in RF propagation, fixed ground station transmit antenna gain and aircraft receive antenna gain, aircraft occasionally make an incorrect decision and lose connectivity.

In another type of RF network, the aircraft broadcasts a downlink message and a plurality of ground stations which receive said message will forward it to a central processing site in order to gain space diversity. In this type of RF network, the central site selects, for each uplink transmission, one of the plurality of ground stations for uplink transmission. In this type of network it is also possible to lose connectivity, or require retransmission, due to improper selection of a ground station for uplink transmission.

FIG. 2 illustrates an aeronautical satellite network comprising a fixed ground station (satellite earth station) 21, a relay satellite 22 supporting an operational coverage area 23, and an aircraft 24 within the operational coverage area. Also shown is an operational exclusion zone 25, for example as may be associated with a radio-quiet zone surrounding an observatory operating in the Radio Astronomy Service. The control system of the aeronautical satellite network may be required to ensure that no aircraft transmissions take place while the aircraft 24 is within the operational exclusion zone 25.

Accurate and timely aircraft position and velocity information can increase the efficiency and reliability of aeronautical communication system control, improve user quality of service, provide a means to verify compliance with regulatory constraints and serve as an aid in regional pricing. Certain avionics on the aircraft may have accurate and timely position and velocity information, but most traditional aeronautical communication systems do not have direct access to this information and most therefore estimate the relevant parameters from signal features available within the communications system itself. Alternatively, if an aeronautical communications system has access to aircraft navigation information and transports this information within the aeronautical communications system, an overhead penalty is incurred due to the opportunity cost of transporting said information.

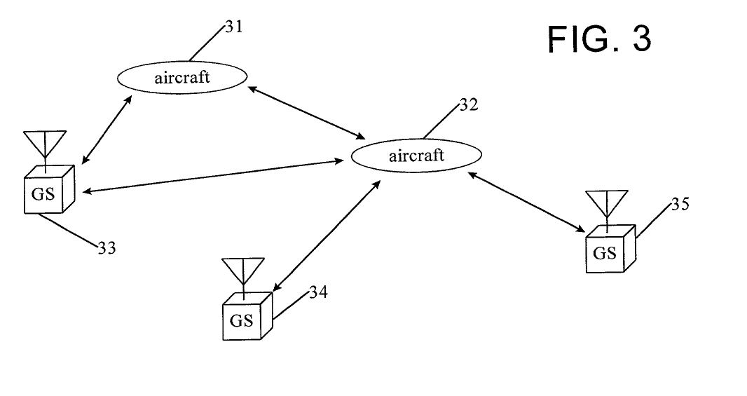

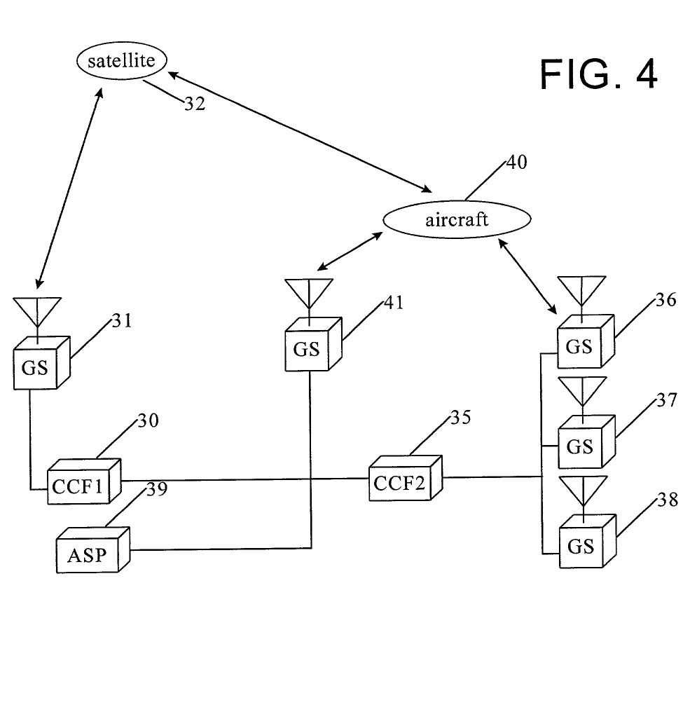

The ICAO-standard VHF Data Link Mode 4 (VDL/4) is an aeronautical communications protocol wherein position and velocity information is exchanged by stations compliant with the protocol. FIG. 3 illustrates several aircraft stations 31 and 32, and several aeronautical (fixed ground) stations 33, 34 and 35, operating in a VDL/4 network. Aircraft 31 is within range of aircraft 32 and ground station 33; aircraft 32 is within range of aircraft 32 and all 3 ground stations 33, 34 and 35. Each aircraft and aeronautical station periodically or aperiodically broadcasts 3D position and velocity information which may be received by other VDL/4 stations within range. This information is used for certain network management and access control protocols within the VDL/4 network, and also supports safety-related surveillance applications such as enhanced situational awareness and flight path deconfliction planning.

FIG. 4 illustrates one embodiment of the present invention, wherein synchronization messages transmitted by a VDL/4-compliant aircraft station 40 are received by a VDL/4-compliant aeronautical ground station 41 and relevant synchronization information contained therein is then transmitted to one or more communications control facilities (CCFx) 30, 35 of one or more other aeronautical communication networks, via appropriate internetworking means, where said relevant synchronization information may be used for e.g. precise ground station handoff control, precise emissions control in the vicinity of defined exclusion zones, selection of appropriate ground transmit stations to enhance aircraft reception probability or selection of appropriate ground transmit stations to maximize spectrum utilization efficiency (i.e., by allowing simultaneous uplink transmission, from several co-frequency ground stations, directional or omnidirectional, to several aircraft in different geographic locations, wherein each aircraft has high probability of error-free reception given the known directionality of the ground stations, if any, and the known distance ratios between the aircraft and the simultaneously-transmitting ground stations). In this illustration, CCF1 30 is a communications control facility for a satellite network comprising ground station 31, satellite 32 and communicating with aircraft 40. Similarly, CCF2 35 is a communications control facility for a terrestrial network comprising ground stations 36, 37, 38 and communicating with aircraft 40.

Relevant synchronization information, derived from VDL/4 synchronization bursts received at VDL/4-compliant ground station 41, can also be delivered to Application Service Providers 39 where said information may be used e.g. to select one of several alternative networks for carriage of particular information to/from the aircraft 40. This might be used, for example, to switch between network service providers based on cost or policy considerations, or to switch between network service providers based on the anticipated communications reliability given the known location of aircraft 40.

A terrestrial or satellite-based system A, or application service provider B, which relies in part on estimates of the 3D position or velocity for aircraft served, benefits by the accuracy of the data contained in or derived from VDL/4 synchronization bursts and avoids the cost and overhead penalty of determining this information autonomously, i.e. using the resources and means wholly contained within system A or otherwise available to the application service provider B. The relevant information is delivered to appropriate facilities of the terrestrial or satellite-based system A, or application service provider B, via terrestrial internetworking means or interwiring means which are typically more cost-effective than the RF networking resources comprising the terrestrial or satellite-based system A.

While preferred embodiments of the present invention have been set forth above, those skilled in the art who have reviewed the present disclosure will readily appreciate that other embodiments can be realized within the scope of the invention. For example, protocols other than those disclosed can be used. Therefore, the present invention should be construed as limited only by the appended claims.

We claim:

1. A method to enhance the reliability, efficiency or quality of service of a terrestrial or satellite-based aeronautical radio communications subnetwork, provide a means to verify compliance with regulatory constraints, or serve as an aid in regional pricing, said method comprising:
(a) receiving synchronization bursts transmitted by VDL/4-compliant aircraft stations by ground station receiving stations;
(b) transmitting information contained in or derived from the synchronization bursts to facilities associated with said terrestrial or satellite-based aeronautical radio communications subnetworks via appropriate internetworking or interwiring means.

2. A method to enhance the reliability, efficiency or quality of service provided by an application service provider, provide a means to verify compliance with regulatory constraints, select among network service providers or serve as an aid in regional pricing, said method comprising:
using information contained within, or derived from,
(a) receiving synchronization bursts transmitted by VDL/4-compliant aircraft stations by ground station receiving stations; and
(b) transmitting information contained in or derived from the synchronization bursts to facilities associated with said application service provider via internetworking or interwiring means.
